(19) United States
(12) Patent Application Publication
(10) Pub. No.: US 2011/0294522 A1
(43) Pub. Date: Dec. 1, 2011

(54) CHARACTER RECOGNIZING SYSTEM AND METHOD FOR THE SAME

(75) Inventors: Chun-Chieh HUANG, Taipei City (TW); Wen-Hung LIAO, Taipei City (TW); Hsin-Yi HUANG, Taipei City (TW)

(73) Assignee: Funwish Co.

(21) Appl. No.: 13/072,827

(22) Filed: Mar. 28, 2011

(30) Foreign Application Priority Data
May 29, 2010 (TW) 099128528

(51) Int. Cl. G06K 9/18; H04W 64/00

(52) U.S. Cl. 455/456.3; 382/186; 345/173; 382/155; 382/185

(57) ABSTRACT

A character recognizing system includes a portable electronic device, a location sensing system and a server system. The portable electronic device captures image of a target to produce a captured image. The location sensing system locates position of the portable electronic device to produce a position information. The server system receives the captured image and the position information via internet for executing recognizing motion.

### BACKGROUND OF THE INVENTION

1. Field of the Invention

The invention related to word recognizing, and in particularly to a system and a method which can recognize word content from a picture image.

2. Description of Prior Art

Because of international trends this year, learning of foreign language receives more attention all over the world.

For the purpose of learning and inquiring foreign language in anytime and anywhere, beside dictionaries and electronic translators, there are many portable electronic devices now, such as mobile phone, provide optical character recognition (OCR) function thereon. User can use those portable electronic devices to learn and to inquire foreign language easily.

For example, learning the most widespread language, English, is to inquire English words by a physical dictionary, or to input English words into an electronic translator or a computer to inquire. For another example, user can also scan English words on a physical file (such as a physical book) by OCR function, and the result will present to user after completing search a database.

However, an English word is constituted by several letters, and the amount of English letters is only twenty six. The present electronic devices, such as mobile phone, electronic translator and laptop, are mostly provided virtual or physical QWERTY keyboard according to each English letters to be typed. Even if user didn't know English letters, he or she can still type the button on the QWERTY keyboard which is looked like the same with the preferred letter, so as to input English words into the translator to inquire.

However, there are some complicated words in foreign country, such as Chinese. The structure of Chinese words is not as simple as that of English words, even if user knew the whole phonetic symbols of Chinese, he or she is still unable to type a Chinese word into the translator to inquire if he or she can not pronounce the Chinese word correctly.

Further, input methods used by a user who is accustomed in Chinese, can't apply to another user who is totally unknown in Chinese.

More particularly, there are more portable electronic devices provide OCR function now in the market, but still, they usually can only be used to recognize printed words on books, leaflets, business cards, and so on, and can not apply to recognize handwritten words.

Although a number of OCR functions can now recognize handwritten words, but they are usually limited in English words recognizing. Respecting to Chinese, complicated structure, written difficulty, different written habits of each person and alternate use between traditional Chinese words and simplified Chinese words, are reasons why handwritten words recognizing is an extremely difficult project.

In Taiwan, there are many handwritten words anywhere (for example, arch of temple in accessory 1 and signboard of street pedlar in accessory 2). Therefore, when a foreigner travels to here, he or she can't inquire Chinese words via dictionary if he or she didn't know Chinese.

Moreover, foreigner is unable to use said input methods in Chinese, so he or she can't use the electronic translator or the computer to inquire too, the purpose of learning can't be reached.

In view of this, without a powerful comparison database, some foreign words (for example, Chinese or Korean), especially handwritten words are very difficult to be recognized. Even if a powerful comparison database is provided, it still not applies to use if the recognizing motion needs tedious executing time and real time inquire is required.

As mentioned above, the recognizing motion further needs other characters to reduce the executing time and raise accuracy to make the recognizing motion easily acceptability.

### SUMMARY OF THE INVENTION

The invention is to provide a character recognizing system and method for the same. The present system provides user to capture an image of a target, and locates the position of the user, and recognizes the word content indicated by the image immediately and accurately by reference to position information of user.

According to the present invention, the character recognizing system includes a portable electronic device, a location sensing system and a server system. The portable electronic device captures image of a target to produce a captured image. The location sensing system locates position of the portable electronic device to produce a position information. The server system receives the captured image and the position information via internet for executing recognizing motion.

In comparison with prior art, the present invention can fetch the word-partition in the captured image of the portable electronic device, and recognizes meaning of the word indicated by the captured image. Further, the system can filter word which is unnecessary to be compared by reference to the position information of the portable electronic device when executing recognizing motion, wherein, the filtered words are not to appear on the position where the portable electronic device at.

Therefore, the present invention can reduce recognizing time, raise performance of recognizing motion, and raise the accuracy of recognizing result. Furthermore, the present invention can recognize successfully not only printed words, but also handwritten words.

### DETAIL DESCRIPTION OF THE INVENTION

FIG. 1 is a schematic view of a system of a preferred embodiment according to the present invention;

FIG. 2 is a block view of a preferred embodiment according to the present invention;

FIG. 3 is a schematic view of a database of a preferred embodiment according to the present invention;

FIG. 4 is a flowchart of a preferred embodiment according to the present invention;

FIG. 5a is a first analysis view of recognizing motion of a preferred embodiment according to the present invention;

FIG. 5b is a second analysis view of recognizing motion of a preferred embodiment according to the present invention;

FIG. 5c is a third analysis view of recognizing motion of a preferred embodiment according to the present invention;

FIG. 5d is a forth analysis view of recognizing motion of a preferred embodiment according to the present invention;

### BRIEF DESCRIPTION OF DRAWING

The preferred embodiments of the present invention will be described in more detail with reference to the accompanying drawings. The drawings are provided for illustrating only, not intended for limiting the present invention.

FIG. 1 is a schematic view of a system of a preferred embodiment according to the present invention. The character recognizing system of the present invention mainly includes a portable electronic device 1 (referred to as the electronic device 1 thereinafter), a location sensing system 2 and a server system 3.

The electronic device 1 captures an image of a target 4 (for example, taking a photograph by a camera) to produce a captured image 41 (as shown in FIG. 5a). The location sensing system 2 locates position of the electronic device 1 to produce a position information PI (as shown in FIG. 3), and the server system 3 receives the captured image 41 and the position information PI to analyze for recognizing word-content information WI (as shown in FIG. 3) indicated by the captured image 41 for user, and provides user to learn via explanation, translation or situated learning related to the word.

FIG. 2 is a block view of a preferred embodiment according to the present invention. The electronic device 1 mainly includes an image capturing module 11, a display screen 12, a central processing unit (CPU) 13, a locating module 14 and a wireless communication module 15.

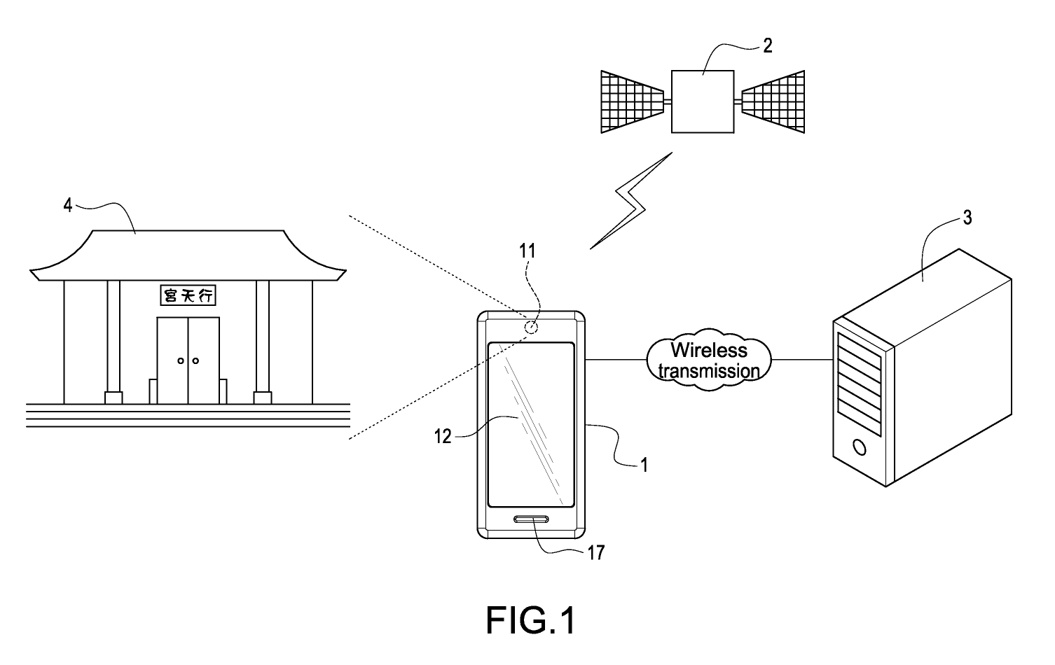

The image capturing module 11 electrically connects to the CPU 13, the image capturing module 11 captures the image of the target 4 in FIG. 1 to produce the captured image 41 in FIG. 5a, and the captured image 41 is transmitted to the CPU 13 to process. The display screen 12 electrically connects to the CPU 13, and the display screen 12 displays the captured image 41 for user viewing.

Wherein, the image capturing module 11 is a charge coupled device (CCD) or a complementary metal oxide semiconductor (CMOS), but not intended to limit the scope of the present invention.

The locating module 14 electrically connects to the CPU 13, the locating module 14 makes a request to the location sensing system, receives the position information PI (as shown in FIG. 3) from the location sensing module, and transmits the received position information PI to the CPU 13 to process.

The wireless communication module 15 electrically connects to the CPU 13, the electronic device 1 connects with the server system 3 through the wireless communication module 15 via internet. The wireless communication module 15 transmits the captured image 41 and the position information PI to the server system 3 to execute recognizing motion, and receives data from the server system 3 after the recognizing motion completed. The electronic device 1 further includes a speaker 16 electrically connects to the CPU 13, the electronic device 1 displays the data received from the server system 3 via the display screen 13 and the speaker 16.

The location sensing system 2 provides locating service for the electronic device 1. More particularly, the location sensing system 2 can be, for example, a global position system (GPS) satellite 21. For another example, the location sensing system 2 can also be a location-based service (LBS) system 22 if the electronic device 1 is a mobile phone. The location sensing system 2 receives the request made by the locating module 14 of the electronic device 1, and locates the position of the electronic device 1 to produce the position information PI, and transmits the produced position information PI to the electronic device 1.

Further, refers to setting reference by user, the location sensing system 2 can execute location automatically whenever the electronic device 1 proceeds to boot or to recognize. It should be mentioned that, the character recognizing system of the present invention can transmits the captured image 41 directly from the electronic device 1 to the server system 3 to execute the recognizing motion without locating by the location sensing system 2, but not intended to limit the scope of the present invention.

The server system 3 mainly includes a wireless communication server 31, a data processing server 32, a recognizing server 33 and a database 34. The wireless communication server 31 connects the wireless communication module 15 via internet, receives the captured image 41 and the position information PI from the electronic device 1.

The data processing server 32 connects to the wireless communication server 31, receives the captured image 41 and the position information PI from the wireless communication server 31, and the captured image 41 is then segmented by the data processing server 32. More particularly, said segment process by the data processing server 32 is to delete background of the captured image 41, and maintains at least one imaging word 43 of the captured image 41 (as shown in FIG. 5d).

Further, if the captured image 41 has several word characters therein, then the data processing server 32 segments the captured image 41 to maintain a plurality of imaging words 43, wherein, each of the imaging words 43 is corresponding to a specific meaning of word which is to be recognized. For example, as shown in FIG. 5d, a first imaging word 431 represents a Chinese word [symbol] , a second imaging word 432 represents a Chinese word [symbol] , and a third imaging word 433 represents a Chinese word [symbol] .

It should be mentioned that, the way to capture the image of the target 4 the user used through the electronic device 1 will affect the status of the imaging word 43 on the captured image 41, such as size, shape and position, but those affections are unpredictable variables. As mentioned above, for the purpose of recognizing smoothly and increasing performance of the recognizing motion by the server system 3, user can select at least one word-partition on the captured image 41 of the electronic device 1M advance.

For example, the display screen 12 of the electronic device 1 can be a touchable display screen 12, therefore, user can touch the touchable display screen 12 directly to select at least one preferred word-partition to produce a selected image 42 (as shown in FIG. 5b), and then transmits the selected image 42 to the server system 3 to recognize.

More particularly, the electronic device 1 can further includes an input module 17 electrically connected to the CPU 13. The input module 17 can be, for example, several operation buttons, so user can select at least one word-partition on the captured image 41 displayed on the display screen 12 to produce the selected image 42 via selecting motion by using the input module 17.

As mentioned above, the electronic device 1 deletes background of the captured image 41 to produce the selected image 42 via the selecting motion made by user. Therefore, the performance of the recognizing motion of the server system 3 can be raised. However, the electronic device 1 transmits the original captured image 41 or the selected image 42 to the server system 3 to recognize, refers to actual use of practices, not intended to limit the scope of the present invention.

FIG. 3 is a schematic view of a database of a preferred embodiment according to the present invention. The recognizing server 33 connects to the wireless communication server 31, the data processing server 32 and the database 34. The recognizing server 33 receives the imaging word 43 and the position information PI from the data processing server 32, and compares the imaging word 43 with comparison data D1 in the database 34 for recognizing the word-content information WI indicated by the imaging word 43.

More particularly, the recognizing server 33 can connects to the wireless communication server 31 directly, or connects to the wireless communication server 31 through a situated learning server 35 (descripted to as following), not intended to limit the scope of the present invention.

Variations of word, such as displacement, rotation, size or word type (for example, printed words and handwritten words) are not affected reading of human being. However, if the recognizing motion is processed by computer server, then the server needs to know the equal relation between an original word and the word with those variations. As mentioned above, the database 34 stores not only a lot of comparison data D1 (for example, Chinese words), but also those comparison data D1 with variations. Therefore, no matter how different between the imaging word 43 and the original word, the recognizing server 33 can still recognize successfully by comparing.

In view of above descriptions, the database 34 must stores prolific comparison data D1 therein through cooperation with experts in this field. However, the more data the database 34 stores therein, the further execution time the recognizing motion needs. So, how to filter unnecessary data effectively for reducing execution time of the recognizing motion, and keeps the accuracy of recognizing result, is just the key point of the present invention.

In this embodiment, for raising the performance of the recognizing motion, the recognizing server 33 filters unnecessary comparison data D1 of the database 34 by reference to the position information PI. For example, if the imaging word 43 indicates several handwritten words such as “m”, “o”, “v”, “i”, “e” (not shown), and one of the words is not so clear cause it can't be recognized into word “m” or “n”. Therefore, the recognizing server 33 refers to the position information PI of the electronic device 1 to determine that the electronic device 1 is now in a movie theater, and the recognizing server 33 can then filter the word “n” and confirm the word-content information WI is word “m”. Nonetheless, the above descriptions are preferred embodiments of the present invention and the scope of the invention is not limited thereto.

When the recognizing server 33 completes the recognizing motion, the server system 3 transmits the word-content information WI to the electronic device 1 via the wireless communication server 31, and the electronic device 1 can then use the word-content information WI, such as explanation, translation pronunciation or searching on the internet.

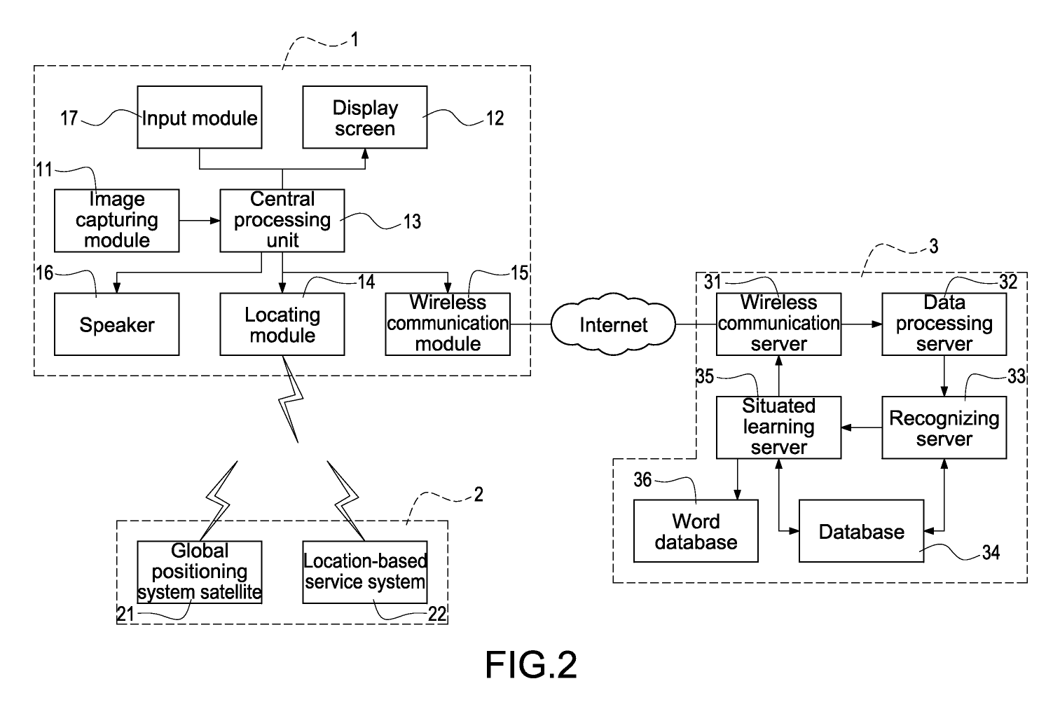

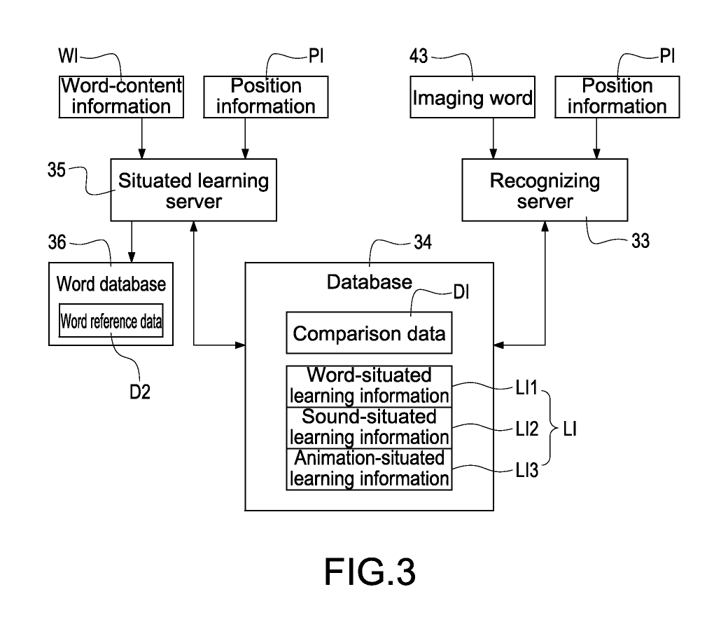

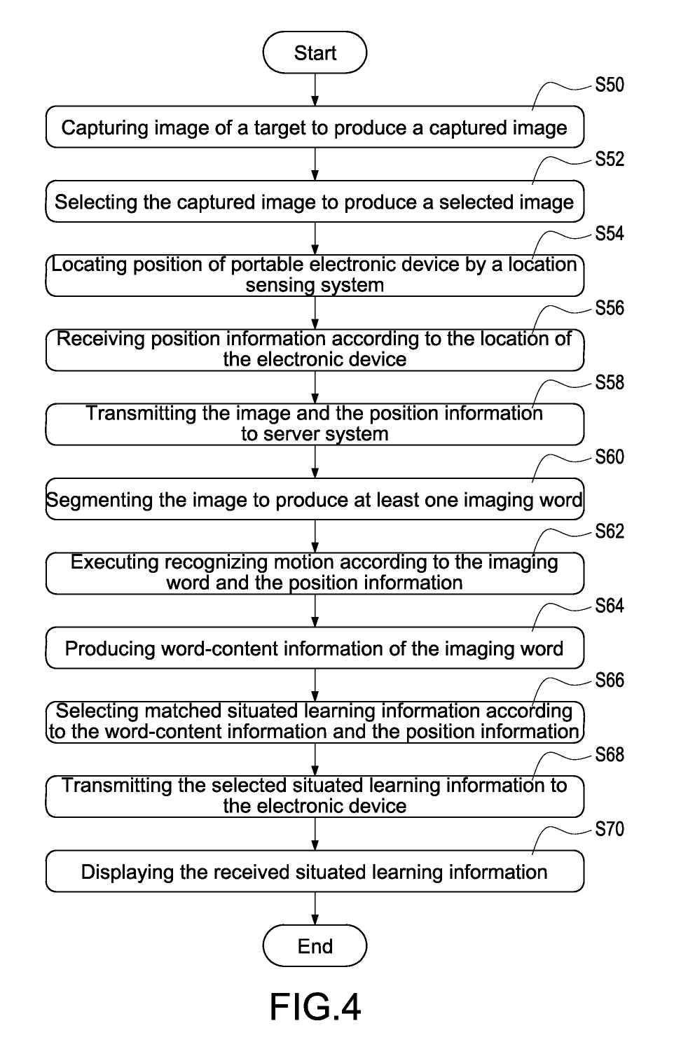

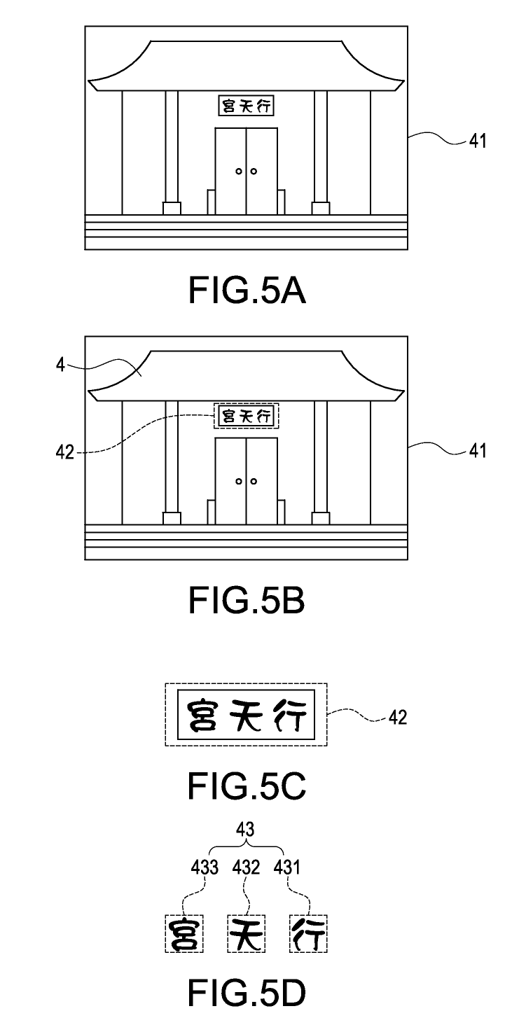

The server system 3 can further include the situated learning server 35 as shown in FIG. 2. The situated learning server 35 connects with the wireless communication server 31, the recognizing server 33 and the database 34. The situated learning server 35 receives the word-content information WI and the position information PI from the recognizing server 33 to select a matched situated learning information LI from the database 34.

The situated learning information LI includes word-situated learning information LI1, sound-situated learning information LI2, animation-situated learning information LI3 and etc. The type of the situated learning information LI respects to the actual use of user, not intended to limit the scope of the present invention.

For example, if the word-content information WI and the position information PI indicates that the electronic device 1 is now located in “ [symbol] ” (a famous temple in Taiwan), then the server system 3 transmits the word-situated learning information LI1, the sound-situated learning information LI2 or the animation-situated learning information LI3 which is according to temple culture in Taiwan to the electronic device 1. The electronic device 1 receives the situated learning information LI to display via the display screen 12 and the speaker 16. Therefore, user can not only learn the meaning of the word, but also learn the related information.

The server system 3 can further include a word database 36 electrically connected to the situated learning server 35, which is a kind of database stored prolific word reference data D2. The situated learning server 35 fetches the situated learning information LI from the database 34 accurately by reference to the word reference data D2 which is according to the position information PI and statistical data (such as word statistics or appearance rate).

For example, if the recognizing server 33 recognizes one of the word-content information WI is “m”, and the electronic device 1 is located in the movie theater, then the word-content information WI must be “movie” by reference to the statistical data. If the electronic device 1 is located at a path of road, then the word-content information is possible be “motor” by reference to the statistical data. And if the electronic device 1 is located in a hotel, then the word-content information is possible to be “motel” by reference to the statistical data.

FIG. 4 is a flowchart of a preferred embodiment according to the present invention. FIG. 5a to FIG. 5d are first analysis view to forth analysis view of recognizing motion of a preferred embodiment according to the present invention. As shown in FIG. 5a, user firstly captures the image of the target 4 shown in FIG. 1 via the electronic device 1 to produce the captured image 41 (step S50).

As shown in FIG. 5b, user can then select at least one word-partition of the captured image 41 via the display screen 12 or the input module 17 to produce the selected image 42 shown in FIG. 5c (step S52). More particularly, user can decide to transmit the original captured image 41 or the selected image 42 to the server system 3 to recognize.

The electronic device 1 then make the request to the location sensing system 2 (the GPS satellite 21 or the LBS system 22) via the locating module 14 to being located (step S54), and receives the position information PI according to the location of the electronic device 1 (step S56). Following the step S56, the electronic device 1 transmits the position information PI, and either the captured image 41 or the selected image 42 to the server system 3 (step S58).

Respecting to FIG. 5d, the server system 3 segments the captured image 41 or the selected image 42 to delete background of the captured image 41 or the selected image 42, so as to produce at least one imaging word 43 (step S60). Following the step S60, the recognizing server 33 executes the recognizing motion by comparing the imaging word 43 and the position information PI with the comparison data D1 of the database 34 (step S62), and produces the word-content information WI of the imaging word 43 after completing the recognizing motion (step S64).

When the word-content information WI is recognized, the situated learning server 35 can selects matched situated learning information LI according to the word-content information WI and the position information PI (step S66). Finally, the server system 3 transmits the selected situated learning information LI to the electronic device 1 (step S68), and the electronic device 1 display the received situated learning information LI via the display screen 12 and the speaker 16 (step S70). Therefore, user can fetch the word content of the image, receives explanation or translation according to the word, and learns related knowledge via the received situated learning information LI.

As the skilled person will appreciate, various changes and modifications can be made to the described embodiment. It is intended to include all such variations, modifications and equivalents which fall within the scope of the present invention, as defined in the accompanying claims.

What is claimed is:

1. A character recognizing system, the character recognizing system recognizing printed words and handwritten words of images and comprising:
a portable electronic device, comprising:
an imaging capturing module capturing an image of a target to produce a captured image;
a central processing unit electrically connected to the image capturing module and receiving the captured image to process;
a locating module electrically connected to the central processing unit and receiving a position information according to position of the portable electronic device and transmitting the position information to the central processing unit; and
a wireless communication module electrically connected to the central processing unit and receiving the captured image and the position information from the central processing unit to transmit externally;
a location sensing system locating the position of the portable electronic device to produce the position information, and to transmit the produced position information to the portable electronic device; and
a server system connected with the portable electronic device via internet, the server system comprising:
a wireless communication server receiving the captured image and the position information from the portable electronic device;
a data processing server connected to the wireless communication server and receiving the captured image to segment to produce at least one imaging word;
a recognizing server connected to the wireless communication server and the data processing server and receiving the imaging word and the position information; and
a database connected to the recognizing server and storing a plurality of comparison data therein;
wherein the recognizing server compares the received imaging word with the comparison data of the database for recognizing word-content information of the imaging word, and the recognizing server refers to the position information when executing recognizing motion to filter the comparison data of the database which needs not to be compared with the imaging word.

2. The character recognizing system of claim 1, wherein the portable electronic device further includes a display screen electrically connected to the central processing unit, and the display screen displays the captured image.

3. The character recognizing system of claim 2, wherein the display screen is a touchable display screen, and the display screen receives external operations to select at least one word partition of the captured image to produce a selected image, and the portable electronic device provides the selected image to the server system to execute the recognizing motion.

4. The character recognizing system of claim 2, wherein the portable electronic device further includes an input module electrically connected to the central processing unit, and the input module receives external operations to select at least one word partition of the captured image to produce a selected image, and the portable electronic device provides the selected image to the server system to execute the recognizing motion.

5. The character recognizing system of claim 1, wherein the image capturing module is a charge coupled device (CCD) or a complementary metal oxide semiconductor (CMOS).

6. The character recognizing system of claim 1, wherein the location sensing system is a location-based service (LBS) system or a global positioning system (GPS) satellite.

7. The character recognizing system of claim 6, wherein the portable electronic device is a mobile phone.

8. The character recognizing system of claim 2, wherein the database stores a plurality of situated learning information therein, and the server system further includes a situated learning server connected to the wireless communication server, the recognizing server and the database, wherein the situated learning server receives the word-content information and the position information to select a matched situated learning information of the database and transmits the matched situated learning information to the portable electronic device to display.

9. The character recognizing system of claim 8, wherein the portable electronic device further includes a speaker electrically connected to the central processing unit, and the portable electronic device displays the received situated learning information via the display screen and the speaker.

10. The character recognizing system of claim 9, wherein the situated learning information includes sound-situated learning information, word-situated learning information and animation-situated learning information.

11. The character recognizing system of claim 8, wherein the server system further includes a word database connected to the situated learning server, the word database stored word reference data therein, and the situated learning server fetches the situated learning information from the database accurately by reference to the word reference data which is according to the position information and statistical data.

12. The character recognizing system of claim 1, wherein the word-content information indicates Chinese words.

13. A character recognizing method applied in a character recognizing system, the character recognizing system comprising a portable electronic device, a location sensing system and a server system, the character recognizing method comprising:
a) capturing an image of a target by the portable electronic device to produce a captured image;
b) locating a position of the portable electronic device by the location sensing system to produce a position information and transmitting the position information to the portable electronic device;
c) transmitting the captured image and the position information to the server system;
d) segmenting the captured image by the server system to produce an imaging word; and
e) executing recognizing motion to produce word-content information of the imaging word according to the imaging word and the position information.

14. The character recognizing method of claim 13, further includes following steps:
f) selecting situated learning information stored in a database of the server system by reference to the word-content information and the position information;
g) transmitting the selected situated learning information to the portable electronic device; and
h) displaying the received situated learning information of the portable electronic device.

15. The character recognizing method of claim 13, wherein the step e further includes following steps:
e1) comparing the imaging word with comparison data stored in a database of the server system; and
e2) filtering the comparison data of the database which is unnecessary to be compared with the imaging word.
